(19) United States
(12) Patent Application Publication
(10) Pub. No.: US 2004/0145068 A1
(43) Pub. Date: Jul. 29, 2004

(54) Method of transferring gas to a liquid by cavitation

(76) Inventor: Donald C. Bullock, Ft. Pierce, FL (US)

Correspondence Address: Donald C. Bullock, 1936 Harbortown Drive, Ft. Pierce, FL, 34946, US

(21) Appl. No.: 10/733,924

(22) Filed: Dec. 11, 2003

Related U.S. Application Data
(60) Provisional application No. 60/442,774, filed on Jan. 27, 2003.

(51) Int. Cl. B01F 3/04

(52) U.S. Cl. 261/91

(57) ABSTRACT

Apparatus and process for creating micro bubbles in a liquid using cavitation are provided. The apparatus includes a rod, cylinder, multi-vanes helical shape or tube with an irregular circumference attached to a drive shaft having a first end and a second end. The first end is coupled to a selectively rotatable power source. The irregular circumference consists of multiple facets having high and low points or areas such that at sufficient angular velocities cavitation zones are created in the liquid following behind each high point. When a gas is supplied to these cavitation zones, the cavitational collapse creates great numbers of micro bubbles which are propelled into the surrounding liquid. Because of their high surface area to volume ratio, these micro bubbles are effective in the transfer of gases such as air and oxygen to a liquid for such purposes as wastewater treatment, aquiculture and gas or stripping of volatile compounds.

### PRIORITY CLAIM

The inventor of this patent application claims the benefit of priority under 35 Section 119(e) of U.S. Provisional Patent Application Serial No. 60/442,774, filed Jan. 27, 2003.

### FIELD OF THE INVENTION

The present invention relates to the field of aeration of a liquid, and more specifically to the field of aeration of a liquid by cavitation.

### BACKGROUND OF THE INVENTION

“Mark's Standard Handbook for Mechanical Engineers” (McGraw Hill, New York, Tenth Edition, 1996) defines cavitation as the formation and collapse of gas or vapor filled bubbles. Further, Mark's reports that these bubbles collapse and can produce shock waves with pressure as high as 60,000 pounds per square inch (410 Mpa). Further, Mark's reports that as many as two million bubbles may collapse over a small area in one second. Cavitation damage causes both corrosion and mechanical effects. Thus, with the exception of acoustical cavitation used for cleaning and welding, traditional technology has been directed toward preventing cavitation. By contrast, the present invention seeks to enhance and maintain multiple cavitational zones over the entire surface of a cylinder which is rotating and partially submerged in a liquid to obtain multiple beneficial effects.

Known aeration apparatuses include surface aerators, diffuser/blowers, and rotor aerators. Surface aerators pump water upward and throw the water into the air. Surface aeration systems require high horsepower motors and consume high amounts of energy in pumping water against the force of gravity. In blower/diffuser systems, compressed air is introduced through diffusers at the bottom of a basin. High horsepower is required to compress the gas and to overcome the water head resistance. Oxygen rises vertically and escapes quickly before effective dispersion into the water can take place. Rotor aerators consist of rotating aerators positioned at the surface of the water receiving treatment. Rotor systems have been known to be expensive to maintain and are high in energy consumption. They cast water into the air, creating an aerosol environment which can release offending odors into the air. Another type of aeration apparatus is an aspirator type aerator. These devices use an electrical motor driven rotating propeller disposed below the surface of the substance being treated. The propeller draws in atmospheric air from an intake port through a draft tube and discharges it into the substance, e.g., the waste water being treated or the water containing marine life. Propeller type aerators may be operated generally horizontally, creating a horizontal rather than vertical flow pattern within a treatment basin.

Known propeller type aeration apparatus include Inhofer et al., U.S. Pat. No. 4,240,990 (Aeration Propeller and Apparatus); Durda et al., U.S. Pat. No. 4,280,911 (Method for Treating Water); Schiller, U.S. Pat. No. 4,741,825 (Mobile Vortex Shield); Schurz, U.S. Pat. No. 4,774,031 (Aerator); Durda, U.S. Pat. No. 4,806,251 (Oscillating Propeller Type Aerator Apparatus and Method); Fuchs et al., U.S. Pat. No. 4,844,816 (Method of Aeration at Specific Depth and Pressure Conditions); Rajendren, U.S. Pat. No. 4,844,843 (Waste Water Aerator having Rotating Compression Blades); Gross, U.S. Pat. No. 4,741,870 (Apparatus for Treatment of Liquids); and Durda, U.S. Pat. No. 4,954,295 (Propeller Aerator with Peripheral Injection of Liquid and Method of Using the Aerator). The above known aerators require high speed propellers for drawing in atmospheric air from an intake port and discharging it into the substance. Accordingly, these known aerators use high amounts of energy to create suction.

### SUMMARY OF THE PRESENT INVENTION

The present invention teaches an apparatus and process for creating micro bubbles in a fluid using cavitation. The apparatus includes a rod, cylinder, or tube shape with an irregular circumference, attached to a drive shaft having a first end and a second end. The first end is coupled to a selectively rotatable power source. The circumference consists of multiple concave facets having high and low points or areas such that at sufficient angular velocities cavitation zones are created in the fluid following behind each high point. These cavitation zones draw gases such as air continuously down each facet of the rod or cylinder from the surface of the fluid such as water. These gases are continuously subjected to the high pressure and impact of the next front or leading edge of the following high point. This following high point creates a zone of violent cavitational collapse causing micro bubbles to be subject to high pressures and be projected violently into the surrounding fluid. Because of their high surface area to volume ratio, these micro bubbles are effective in the transfer of gases such as air and oxygen to a fluid for such purposes as wastewater treatment, aquiculture and gas or removal of volatile compounds. Under certain conditions the fluid along the cavitational interface is vaporized causing the expelled micro bubbles to contain a vapor of the fluid which further enhances transfer of gas to the fluid.

As an oxygen transfer device, the apparatus of the present invention eliminates the need for several elements traditionally associated with aeration devices such as propellers, pressurized air sources, and small orifices.

It is an object of the present invention to provide an apparatus for creating vacuum channels to draw air or gasses from the surface of a liquid.

It is a further object of the present invention to create continuous smashing or implosions of gasses in the zones of cavitational collapse at high-pressures to create massive amounts of micro bubbles.

It is a still further object of the present invention to violently propel micro bubbles radially into the surrounding liquid.

It is a still further object of the present invention to create an outwardly spiral current in surrounding liquid to mix micro bubbles into the surrounding liquid.

It is a still further object of the present invention to break up and dissolve solids or semi-solids in a liquid that impinge the zones of cavitational collapse.

Certain liquids and conditions cause a partial vaporization of the liquid in the zone of cavitation such that the micro bubbles created in the zone of cavitational collapse contain a vapor from the surrounding liquid. All of the above effects facilitate and enhance the dissolving of a gas into a liquid. This present invention is a simple apparatus which accomplishes a complex process and eliminates many of the elements and disadvantages of previous devices directed at the same goals. Previous inventions, particularly propeller types, involve the rapid acceleration of massive amounts of liquids to obtain suction to draw in the gas and to disperse the bubbles. This rapid acceleration of a liquid such as water uses high amounts of energy, most of which does not contribute objective of dissolving the gas into the liquid. By contrast, the present invention does not seek the acceleration of the water but rather the dislocation of space behind the following edges of the high points on the cylindrical shape. It is this dislocation of space that causes the cavitation.

Due to friction and turbulence at the surface of the cylinder of the present invention, a spiral current is generated in the surrounding liquid. This spiral current forces the bubbles to take a relatively long, circuitous path to the surface. Thus, the residence time of the bubbles in the liquid column is greatly increased allowing more time for the gas to dissolve into the liquid.

The present invention relates to an aerator for treatment of liquid. More particularly, the present invention relates to an aerator apparatus which efficiently mixes and improves the dissolved oxygen content in a liquid. Aeration processes are utilized in the treatment of liquid for the purpose of mixing and increasing the dissolved oxygen (DO) content of the liquid. When used in a wastewater treatment process, bacteria and other microorganisms are supplied with oxygen to break down organic matter within the wastewater in a purification process. In other applications, aeration processes are used in the treatment of water to meet the dissolved oxygen requirements for supporting fish life and other aquatic organisms. The present invention seeks to enhance and maintain multiple cavitational zones over the entire surface of a cylindrical shape which is rotating and partially submerged in a liquid to obtain the aforementioned objects.

The spinning cylindrical shape of the present invention can be comprised of a stack of fans, a helical configuration or any irregular surface that will create cavitation at the interface of the gas and liquid. When stacked fans or helical configurations are incorporated into the instant invention, additional gases can be supplied to the cavitational zones.

### BRIEF DESCRIPTION OF THE DRAWINGS

FIG. 1 is a top view of simplified oxygen transfer rod of the present invention with explosive view of one facet.

FIG. 2 is a top view of a hollow column aeration device of the present invention with helical internal air vane.

FIG. 3 is a side view of hollow column aeration device of the present invention with helical internal air vane.

### DETAILED DESCRIPTION OF THE INVENTION

Many of the attendant advantages of the present invention will be readily appreciated as the same become better understood by reference to the following detailed description when considered in connection with the accompanying drawings.

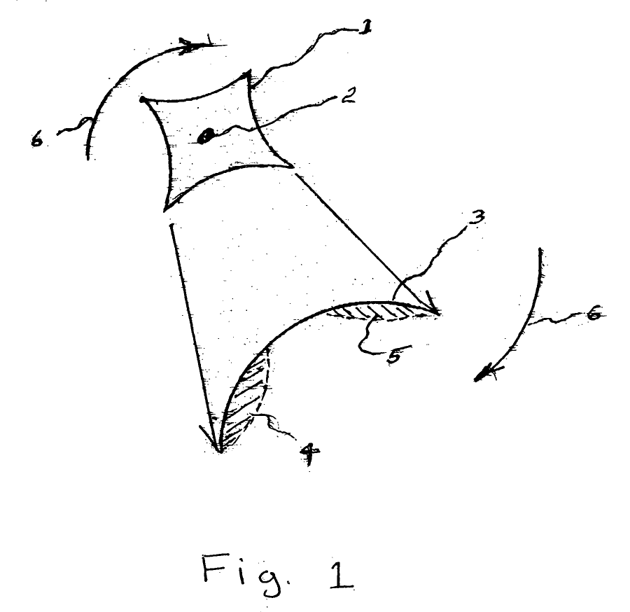

Please refer to FIG. 1, wherein is shown a top view of an oxygen transfer rod with an explosive view of one facet. This embodiment is present to show the cavitation generating aspects of the present invention. The four-sided rod 1 includes a center shaft 2 connected to a rotatable power source (not shown) capable of spinning the rod in direction 6 at angular velocities to exceed a tip or high point speed of 10 feet per second.

The expanded view shows one facet 3 moving at high angular velocity in the receiving liquid such as water in direction 6. Cavitational zone 4 shows the area where air is drawn down the rod from the surface of the water. Cavitational collapse zone 5 shows the area of violent implosion where the gas is fractionated or smashed into numerous micro bubbles and accelerated radially out into the surrounding water or receiving liquid.

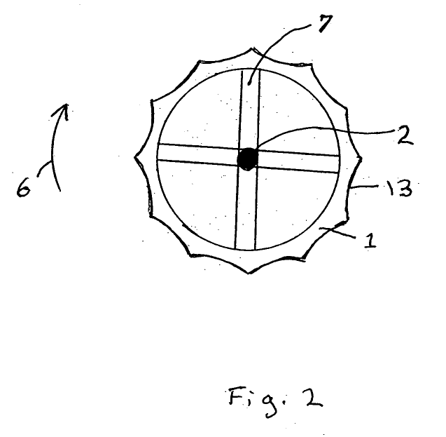

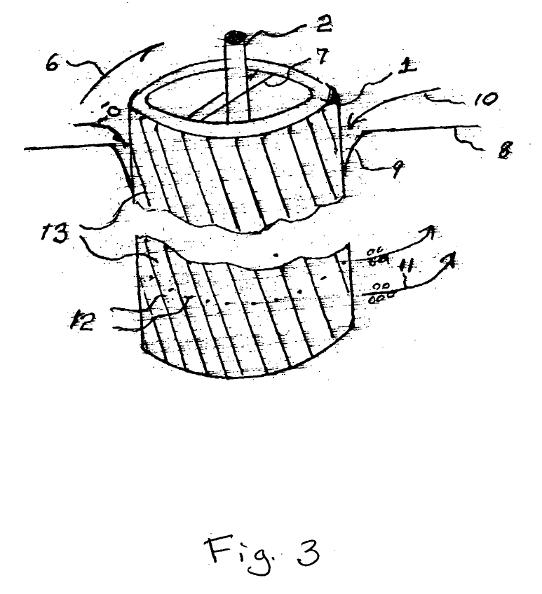

FIGS. 2 and 3 show a top and side view of a hollow column aeration device with a helical internal air vane and radial air supply openings. Hollow column 1 with multiple irregular faceted circumference 13 is connected to centered shaft 2 which is coupled to a rotatable power source (not shown) capable of providing high angular velocities to circumference 13 in direction 6 while the column is partially or almost totally submerged in the receiving liquid or water. Water surface line 8 and vortex 9 are typical. At cavitational speed, air 10 is drawn down each facet and then smashed into numerous micro bubbles and projected radially outward into the receiving liquid in the direction of path 11.

Internal helical air vane 7 provides additional air to the radial openings 12 for the lower regions of the device. Vane 7 and openings 12 supply additional air or gas to the cavitational zones.

It will be understood that this disclosure is, in many respects, only illustrative. Changes may be made in details, particularly in matters of shape, size, material, and arrangement of parts without exceeding the scope of the invention. Accordingly, the scope of the invention is as defined in the language of the appended claims.

1. A method of transferring and dissolving a gas into a liquid by cavitation, comprising the steps of:
a.) providing a continuous cavitation generator comprising an elongate drive shaft having a first end and a second end, the first end being coupled to a selectively rotatable power source, the second end being coupled to a rod, tube, or column
having a multifaceted, exterior circumference, said circumference comprising a series of high points;
b.) partially submerging the rod, tube or column in the receiving liquid;
c.) causing the rod, tube or column to rotate such that at appropriate angular velocities a cavitational zone is created behind each high point of the multifaceted exterior circumference such that the gas is drawn from the surface of the liquid into each cavitational zone; and
d.) the successive high point of each facet causes a zone of cavitational collapse thus creating micro bubbles which are projected outwardly and continuously into the surrounding receiving liquid.

2. The method in accordance with claim 1, wherein the rotational speed, diameter and configuration of the circumference of the rod, tube or column cause vaporization of the receiving liquid along the interface of the cavitational zone and the liquid such that the micro bubbles created contain a vapor of the surrounding liquid to enhance dissolving action.

3. The method in accordance with claim 1, wherein the rotational speed, diameter and configuration of the circumference of the rod, tube or column cause vaporization of the receiving liquid along the interface of the cavitational zone and the liquid such that the micro bubbles created contain a vapor of the surrounding liquid to remove volatile compounds or gases from the receiving liquid.

4. The method in accordance with claim 1, wherein the rotational speed, diameter and configuration of the circumference of the rod, tube or column cause sufficient pressure and mechanical impact in the zones of cavitational collapse to enhance the breaking up and dissolving of solids and semi-solids in the receiving liquid or liquid.

5. An improved device for transferring and dissolving a gas to a liquid, comprising:
a.) an elongated shaft having an upper end and a lower end;
b.) means associated with the upper end of said shaft for rotating said shaft;
c.) said shaft comprising a multifaceted exterior circumference, said exterior further comprising a series of high points,
d.) said shaft being partially submerged in the liquid;
e.) a cavitational zone is created behind each high point when the shaft is rotated;
f.) gas is drawn into each cavitational zone;
g.) zone of cavitational collapse is created immediately following each high point creating micro bubbles under sufficient pressure to expel the micro bubbles outward into the surrounding liquid causing the dissolving of the gas into the liquid.

6. The device of claim 5 wherein the liquid is water.

7. The device of claim 5 wherein the gas is air.

8. The device of claim 5 wherein the gas is oxygen.

9. The device of claim 5 wherein the liquid is water and the gas is air.

10. The device of claim 5 wherein the liquid is water and the gas is oxygen.

11. A method of creating an open cylindrical gas filled cavity in a liquid to transfer the gas to the liquid comprising a spinning stack of fans, a helical configuration or an irregular cylindrical surface driven by a shaft attached to a suitable rotational power source such that the gas flows down from the surface of the liquid and outward to the surface of the cylindrical cavity where cavitational effects at the gas-liquid interface cause massive amounts of micro bubbles to be expelled radially into the liquid.
